(19) United States
(12) Patent Application Publication
(10) Pub. No.: US 2002/0158056 A1
(43) Pub. Date: Oct. 31, 2002

(54) Electric arc welding machine

(76) Inventor: Jason Ho, Kaohsiung (TW)

Correspondence Address: DELLETT AND WALTERS, 310 S.W. FOURTH AVENUE, SUITE 1101, PORTLAND, OR, 97204, US

(21) Appl. No.: 09/843,593

(22) Filed: Apr. 26, 2001

(51) Int. Cl. B23K 9/10

(52) U.S. Cl. 219/132; 219/130.1

(57) ABSTRACT

An electric arc welding machine has a housing, an arc-generating device, a current adjusting device and a controller. The arc-generating device is mounted in the housing to generate an electric arc. The current adjusting device has a rotatable shaft, a movable magnetic core and an induction coil. A motor is mounted in the housing to rotate the current adjusting device shaft through a transmission device. The controller has a remote switch unit and a receiver. The switch unit is used to send a control signal from a separate location far from the welding machine. The receiver is mounted on the housing and is electrically connected to the motor to receive the signal sent from the switch unit. The user can adjust the current applied to the arc-generating device at a separate location far from the welding machine. The use of the welding machine becomes more convenient.

### BACKGROUND OF THE INVENTION

1. Field of the Invention

The present invention relates to an electric arc welding machine, and more particularly to an electric arc welding machine with a remote controller.

2. Description of Related Art

With reference to FIG. 4, a conventional electric arc welding machine substantially has a housing (30), an arc-generating device (not shown) and a current adjusting device. The arc-generating device is mounted in the housing (30). A welding lead (not shown) and a work lead (not shown) are connected to the arc-generating device. A clamp is attached to the free end of the work lead to clamp one of the objects to be welded, and a holder is attached to the free end of the welding lead to hold a welding rod. Accordingly, an arc will be generated when the welding rod contacts the clamped object to combine the objects. The current adjusting device is used to adjust the current applied to the arc-generating device. The current adjusting device substantially comprises a rotatable shaft (32), a magnetic core (not shown) and an induction coil (not shown). The shaft (32) extends out from the housing (30) and has a handle (322) attached to the shaft (32) so a user can rotate the shaft (32). The magnet core is moveably mounted in the housing. The induction coil is electrically connected to the arc-generating device.

A transmitting device is arranged between the (32) shaft and the magnetic core. When the user rotates the shaft (32), the transmitting device will cause the magnetic core to move relative to the housing. Accordingly, the current applied to the arc-generating device is changed by means of the interaction between the moving magnetic core and the induction coil.

However, because the conventional current adjusting device is manual, the person doing the welding must stop work to adjust the current or work in very close proximity to the conventional adjusting device. Consequently, operating the conventional current adjusting device is inconvenient.

To overcome the shortcomings, the present invention tends to provide an improved welding machine to mitigate or obviate the aforementioned problems.

### SUMMARY OF THE INVENTION

The main objective of the invention is to provide an improved electric arc welding machine with a remote controller to control the welding machine from a separate position far from the welding machine. The welding machine has a housing, an arc-generating device, a current adjusting device and a controller. The arc-generating device is mounted in the housing to generate an electric arc. The current adjusting device has a rotatable shaft, a movable magnetic core and an induction coil. A motor is mounted in the housing to rotate the shaft through a transmission device. The controller has a remote switch unit and a receiver. The switch unit is used to send a control signal from a separate location far from the welding machine. The receiver is mounted on the housing and is electrically connected to the motor to receive the signal sent from the switch unit. Consequently, the user can adjust the current applied to the arc-generating device at a separate location far from the welding machine. The use of the welding machine becomes more convenient.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electric arc welding machine in accordance with the present invention;

FIG. 2 is a top plan view of the welding machine in FIG. 1;

FIG. 3 is a perspective view of another embodiment of the electric arc welding machine in accordance with the present invention; and

FIG. 4 is a perspective view of a conventional electric arc welding machine in accordance with the prior art.

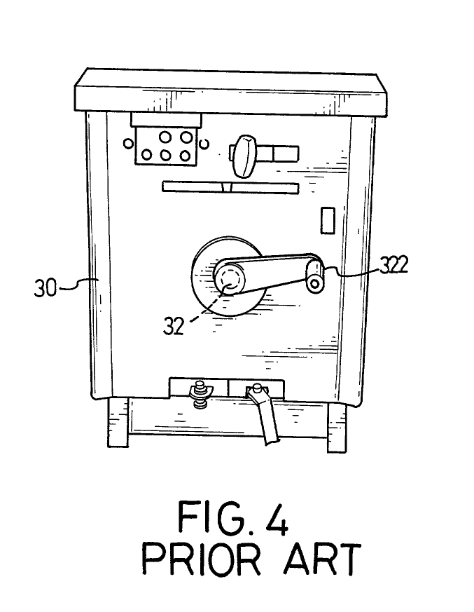

### DETAILED DESCRIPTION OF PREFERRED EMBODIMENT

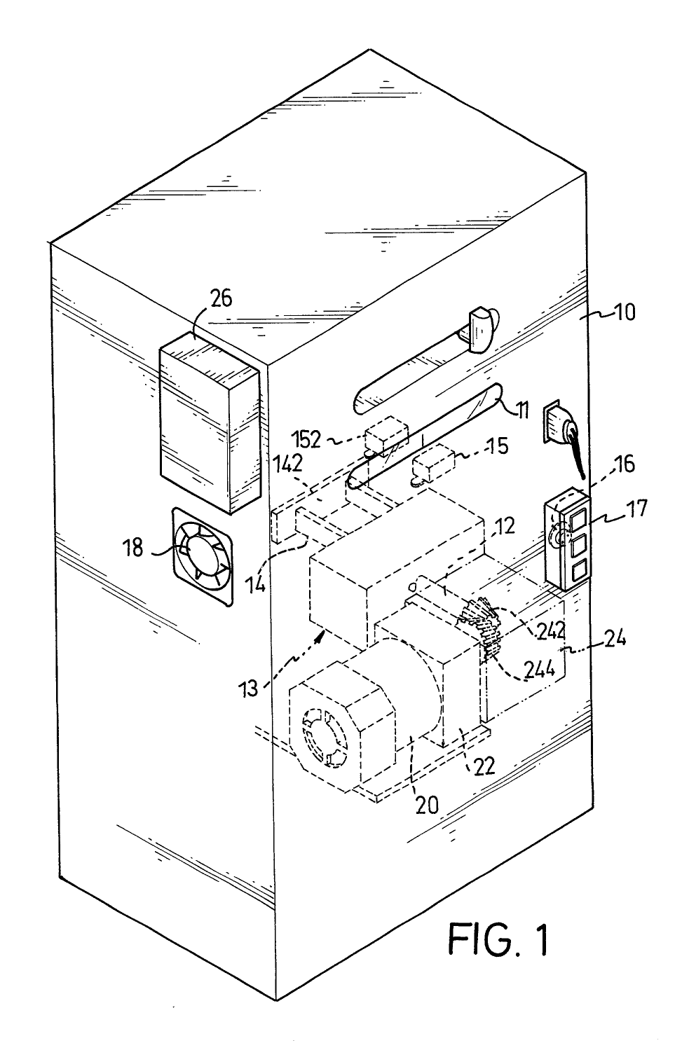

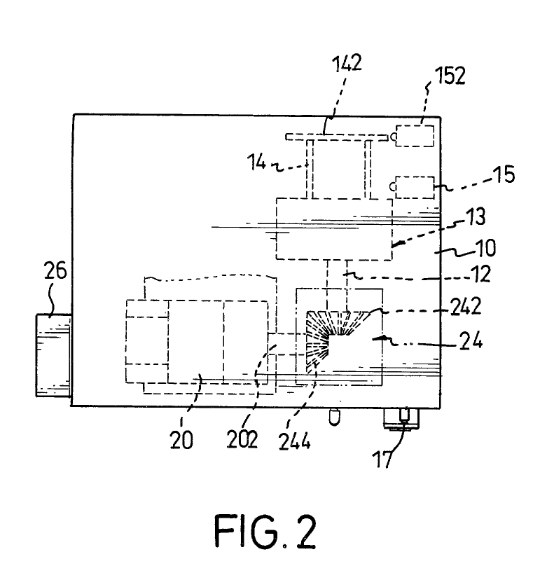

With reference to FIGS. 1 and 2, an electric arc welding machine in accordance with the present invention comprises a housing (10), an arc-generating device (not shown), a current adjusting device and a controller. The arc-generating device is mounted in the housing to generate an electric arc with a current for welding. An indicator (11) is mounted on the housing (10) to show the current applied to the arc-generating device.

The current adjusting device substantially comprises a rotatable shaft (12), a movable magnetic core (14) and an induction coil (not shown). A transmitting device (13) is arranged between the shaft (12) and the magnetic core (14) to move the magnetic core (14) relative to the housing (10) as the shaft (12) rotates. A motor (20) is mounted in the housing (10) and has a rotating shaft (202). A reduction device (22) is always mounted on the motor (20) to reduce the speed of the shaft (12). A transmitting device (24) is arranged between the shaft (202) of the motor (20) and the shaft (12). In practice, the transmitting device (24) comprises two bevel gears (242, 244) respectively mounted on the shaft (12) and the motor shaft (202) and engaging with each other. Consequently, the motor (20) can rotate the shaft (12) through the transmission of the transmitting device (24).

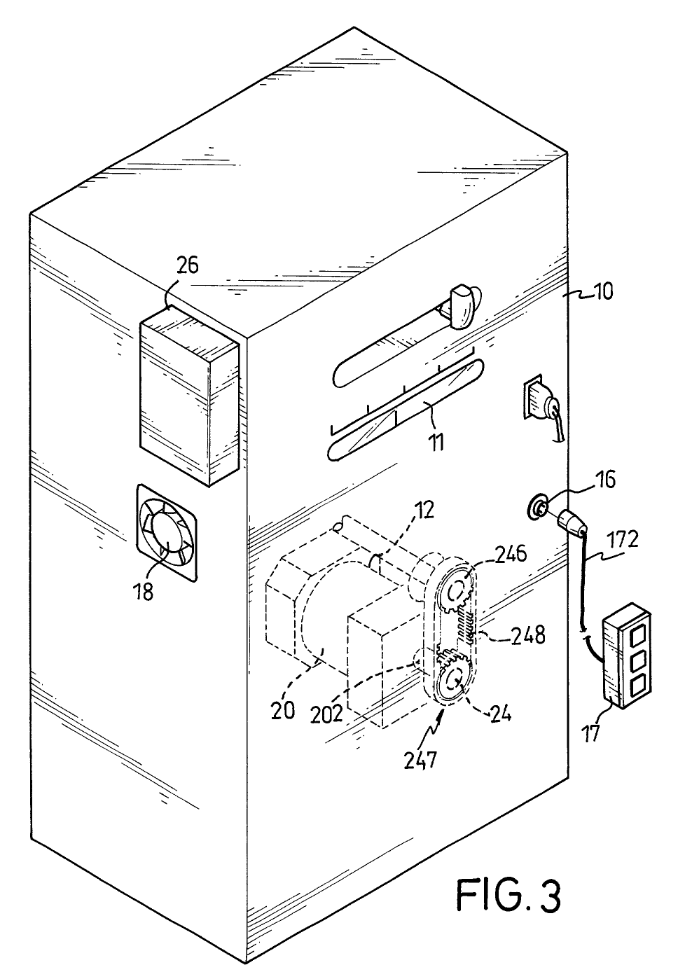

In another embodiment, with reference to FIG. 3, the transmitting device (24) is a belt drive assembly. The belt drive assembly comprises two wheels (246,247) respectively mounted on the shaft (12) and the motor shaft (202) and a belt (248) mounted around the wheels (246, 247). Accordingly, the motor (20) can rotate the shaft (12) through the transmission of the belt drive assembly. In a further embodiment, the transmitting device (24) is a chain transmission mechanism or the like.

The controller comprises a remote switch unit (not shown) and a receiver (26). The remote switch unit has multiple buttons. The switch unit sends out a control signal when one of the buttons is pushed. The receiver (26) is mounted on the housing (10). The receiver (26) is used to receive the signal sent from the switch unit and electrically connected to the motor (20). Consequently, the motor (20) can be actuated or stopped when the user pushes the buttons on the remote switch unit. When the motor (20) is actuated, the shaft (12) will be rotated by the transmission of the transmitting device (24). The magnetic core (14) will move relative to the housing (10) through the transmission of the transmitting device (13). Furthermore, the current applied to the arc-generating device is changed by means of the interaction between the moving magnetic core (14) and the induction coil. Accordingly, the user can control the welding machine and adjust the current applied to the arc-generating device at a position far from the welding machine. The use of the welding machine becomes more convenient.

With reference to FIGS. 1 and 3, a socket (16) is mounted on the housing (10) and is electrically connected to the motor (20) and the arc-generating device. A switch box (17) is attached to the socket (16) directly or through a cable (172) as shown in FIG. 3. The switch box (17) comprises multiple buttons. Consequently, the operation of the arc-generating device and the motor (20) can be controlled through the switch box (17). The user can control the welding machine or adjust the current applied to the arc-generating device far from the welding machine.

In addition, with reference to FIGS. 1 and 2, two limit switches (15, 152) are separately mounted in the housing (10) along the direction of the travel of the magnetic core (14). Both of the limit switches (15, 152) are electrically connected to the motor (20). A rod (142) is secured to the magnetic core (14) and corresponds to the limit switches (15, 152). The rod (142) moves with the magnetic core (14) when the current adjusting device is in operation. When the rod (14) touches one of the limit switches (15, 152), the motor (20) will stop. The travel of the magnetic core (14) is limited between the limit switches (15, 152). Overload of the motor (20) can be avoided.

A fan (18) is mounted on the housing (10) to exhaust the heat generated during the operation of the welding machine. Overheat of the welding machine can be avoided.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electric arc welding machine comprising:
a housing;
an arc-generating device mounted in the housing to generate an electric arc with a current;
a current adjusting device mounted in the housing to change the current applied to the arc-generating device and having
a current adjusting device shaft rotatably mounted in the housing;
a magnetic core moveably mounted in the housing;
a first transmitting device arranged between the current adjusting device shaft and the magnetic core to move the magnetic core relative to the housing as the current adjusting device shaft is rotated; and
an induction coil electrically connected to the arc-generating device and interacting with the magnetic core;
an indicator mounted on the housing to show the current applied to the arc-generating device;
a motor mounted in the housing and having a rotating shaft;
a second transmitting device arranged between the motor shaft and the current adjusting device shaft to rotate the current adjusting device shaft relative to the housing; and
a controller having a remote switch unit for sending a control signal from a separate location far from the welding machine and a receiver mounted on the housing and electrically connected to the motor to receive the signal sent from the switch unit so as to control the motor.

2. The welding machine as claimed in claim 1, wherein two limit switches are separately mounted in the housing along the direction of travel of the magnetic core and electrically connected to the motor; and
a rod is secured to the magnetic core and corresponds to the limit switches,
whereby when the rod touches one of the limit switches, the motor will stop; and travel of the magnetic core is limited between the limit switches.

3. The welding machine as claimed in claim 1 further comprising a socket mounted on the housing; and
a switch box attached to the socket and electrically connected to the motor to control the motor.

4. The welding machine as claimed in claim 1 further comprising a socket mounted on the housing; and
a switch box attached to the socket through a cable and electrically connected to the motor to control the motor.

5. The welding machine as claimed in claim 1, the second transmitting device comprises two bevel gears respectively mounted on the motor shaft and the current adjusting device shaft and engaging with each other.

6. The welding machine as claimed in claim 1, the second transmitting device is a belt drive assembly and has
two wheels respectively mounted on the motor shaft and the current adjusting device shaft; and
a belt going around the wheels.

7. The welding machine as claimed in claim 1, the second transmitting device is a chain transmission mechanism.

8. The welding machine as claimed in claim 1 further comprising a fan mounted on the housing to exhaust heat generated during the operation of the welding machine.

9. The welding machine as claimed in claim 1 further comprising a reduction device mounted on the motor to reduce the speed of the current adjusting device shaft.
